(19) United States
(12) Patent Application Publication
(10) Pub. No.: US 2008/0230432 A1
(43) Pub. Date: Sep. 25, 2008

(54) Blister Packs

(75) Inventors: Jonathan Bobbett, Kent (GB); Jonathan Neal, Kent (GB)

Correspondence Address: CONNOLLY BOVE LODGE & HUTZ LLP, 1875 EYE STREET, N.W., SUITE 1100, WASHINGTON, DC, 20036, US

(73) Assignee: PILL PROTECT LIMITED, Kent (GB)

(21) Appl. No.: 11/718,673

(22) PCT Filed: Nov. 3, 2005
(86) PCT No.: PCT/GB2005/050192

§ 371 Date: Jan. 28, 2008

(30) Foreign Application Priority Data
Nov. 5, 2004 (GB) 0424429.9

(51) Int. Cl. B65D 75/34; B65D 83/04; G09F 3/00

(52) U.S. Cl. 206/531; 40/674; 206/469; 206/459.5

(57) ABSTRACT

The present invention relates to blister packs and labels for a blister pack. In particular, it relates to a label (a) which makes it more difficult for a child to release a medicament from the blister pack without making it unduly difficult for the elderly or infirm to remove the medicament. We describe a medicament blister pack label comprising a sheet having points of weakness (11) defining non-specified medicament release regions.

The present invention relates to blister packs and, in particular, to a label for a blister pack. More particularly, it relates to a label which makes it more difficult for a child to release a medicament from the blister pack without making it unduly difficult for the elderly or infirm to remove the medicament.

Conventional blister cards or packs typically include a plastics sheet material moulded to provide a tray comprising a plurality of recesses into each of which recesses is placed a medicament, typically in tablet or capsule form. The medicaments are held in place by means of a foil retaining sheet. When the patient wishes to use the medicament, they push the tablet or capsule through the foil retaining sheet. For ease of release, the foil retaining sheet is usually rather thin and easily ruptured. This raises issues of child safety as it becomes very easy for a child to tamper with the blister pack, so releasing the medication. One approach to improving the child-resistance of a blister pack is to increase the thickness of the foil in order to require greater strength in order to push the medicament through the foil retaining sheet. However, one needs to be careful to avoid producing a blister pack from which elderly or infirm might find it impossible to gain access to their medicament.

Accordingly, there is a need to provide a blister card that provides resistance to tampering by children but allows the elderly or infirm to release their medicament without undue difficulty. WO 02/32666 describes one approach in which a first sheet material is attached to the foil of a conventional blister pack by a temporary adhesive. The first sheet covers all of the individual medicament recesses, but is itself of smaller overall dimensions than the blister pack itself. Overlaying the first sheet is a second sheet material. This is provided with a permanent adhesive and is larger than the first sheet material such that where it overlies the first sheet, it is adhered thereto by the permanent adhesive, but where it does not overlie the first sheet, it adheres by the permanent adhesive to the foil retaining sheet of the blister pack. The second sheet includes medicament release zones each defined by a plurality of points of weakness in the form of perforations in specific shapes corresponding to each medicament recess. The user peels off a portion of the second sheet adjacent the location of a medicament. The perforations ensure selective removal only of that part adjacent the chosen medicament and the use of a permanent adhesive provides that a respective portion of the first sheet material is also removed. The user can then press the medicament through the foil layer as usual.

However, the arrangement of WO 02/32666 requires careful cutting and assembly of the components. The present invention seeks to provide an alternative blister pack label.

In its broadest sense, the present invention provides a medicament blister pack label all provided with a plurality of points of weakness across substantially the entire label.

Typically, each point of weakness is formed by a perforation, a slit or a score line.

The label has first and second faces and the points of weakness may be formed partially in either the upper or lower surface or may extend from the first face through the label to the second face.

The label may be formed from any suitable material such as metal foil, metalised plastics, plastics, materials or paper.

Preferably, the points of weakness are provided substantially uniformly across the entire label. Suitably, the label is a printable material, such as a paper material. Suitably the paper material is a machine-coated or blade-coated paper. Preferably, the paper has a weight of 20 g/m² or more, more preferably from 50 to 400 g/m²; even more preferably from 60 to 200 g/m², most preferably from 70 to 150 g/m². Advantageously, the paper has a weight of from 80 to 120 g/m², suitably about 85 g/m².

In a second aspect, the present invention provides a medicament retaining sheet for a medicament blister pack, the retaining sheet comprising a first sheet having first and second faces and a second sheet having first and second faces, wherein the first face of the second sheet and the second face of the first sheet are opposed and bonded together. The second sheet is provided with a plurality of points of weakness across substantially the entire sheet.

Preferably, the first sheet has a weight of from 15 to 100 g/m²; more preferably from 20 to 50 g/m²; even more preferably about 30 g/m².

Preferably, the first sheet has a thickness of from 15 to 120 μm; more preferably from 20 to 60 μm; even more preferably about 30 μm.

Preferably, the second sheet is a metallic foil or a metalised plastics film.

In a preferred embodiment the second sheet includes points of weakness formed substantially across the entire sheet; the first sheet is preferably comprised of a metal foil or a metalised plastics material; and the second sheet may be formed from any suitable material such as metal foil, metalised plastics, plastics or paper. Preferably, the second sheet material is a paper or synthetic material having preferred properties as outlined in relation to a first aspect of the invention, above. In an alternative arrangement the respective sheets may be interchanged. The points of weakness are formed in either of the faces of the preferred embodiment and in an alternative arrangement will extend from a first face and through one of the sheets to the second face thereof.

In a third aspect the present invention provides a medicament retaining sheet for a medicament blister pack, the retaining sheet having upper and lower surfaces and comprising a sheet including points of weakness formed across substantially the entire upper surface thereof, provided that the points of weakness do not penetrate or extend from the upper surface through the sheet to the lower surface of said sheet.

Preferably, the sheet material is a metal foil or a metalised plastics sheet.

Preferably, the points of weakness are formed by kiss-cutting or laser-cutting. The points may be formed in either the first or the second face of the medicament retaining sheet.

Preferably, the foil sheet is from 6 to 50 μm in thickness.

In a fourth aspect the present invention provides a medicament blister pack comprising a medicament tray having an upper surface to which is bonded a medicament retaining sheet as described above.

Preferably, the medicament tray comprises a moulded plastics tray having a plurality of individual medicament-receiving cavities. Suitably, the tray is formed by vacuum moulding.

Suitably, the lines of weakness are defined by a plurality of parallel lines of point of weakness, optionally further including a second plurality of parallel lines transecting the first lines.

Preferably, the lines of weakness are spaced such that each medicament-receiving cavity is overlaid by more than one line of weakness.

The above and other aspects of the present invention will now be illustrated in further detail, by way of example only, with reference to the accompanying drawings in which:

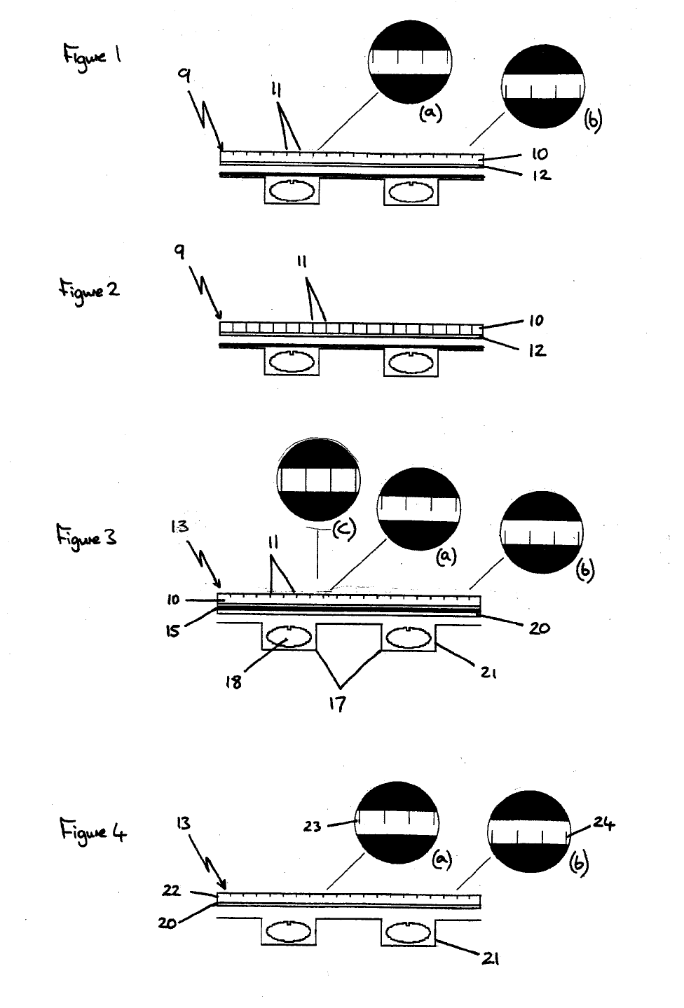

FIG. 1a & b is an schematic exploded sectional view of a blister pack incorporating a first embodiment of a label in accordance with the first aspect of the present invention, with inserts illustrative of points of weakness;

FIG. 2 is a schematic exploded sectional view of a blister pack incorporating a second embodiment of a label in accordance with the first aspect of the present invention;

FIG. 3a-c is a schematic exploded sectional view of a blister pack incorporating a medicament retaining sheet in accordance with the second aspect of the present invention;

FIG. 4a & b is a schematic sectional view of an alternative exploded embodiment of blister packs incorporating medicament retaining sheets in accordance with the present invention; and

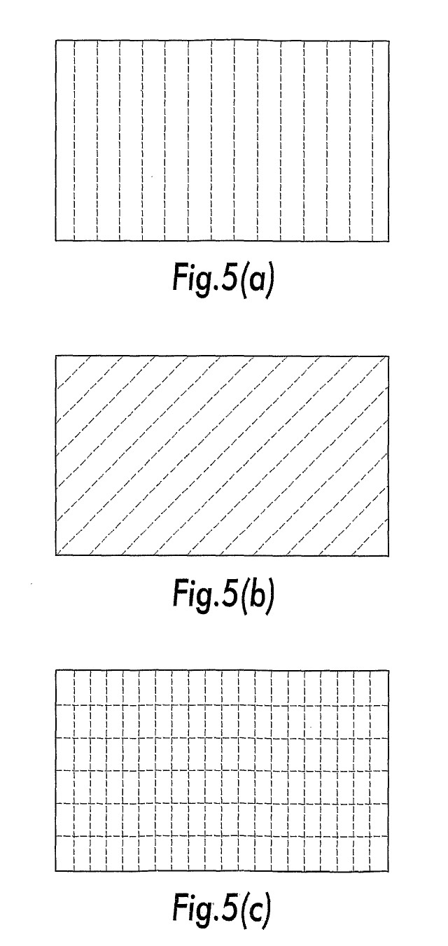

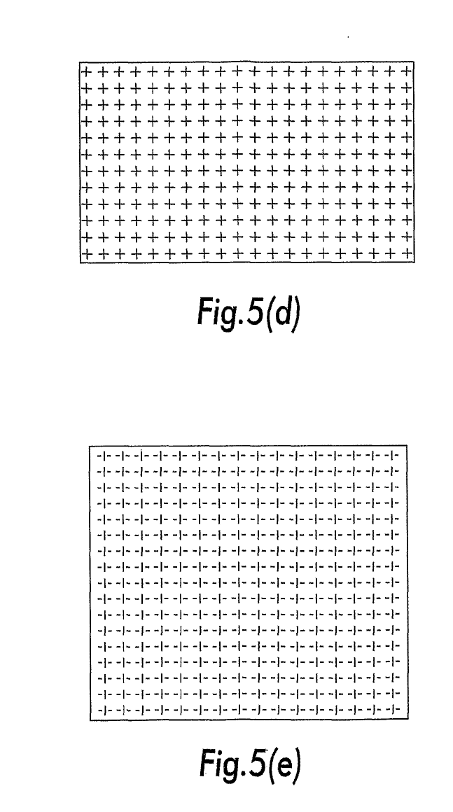

FIGS. 5a-d are plan views of suitable arrangements for points of weakness for embodiments of the present invention;

Referring to FIGS. 1 and 2, there are shown blister pack labels 9 comprising a sheet material IO and an adhesive layer 12. A permanent adhesive 12 may be applied to the sheet 10, or directly to the blister pack (not shown), for example by roller-coating. Any adhesive composition compatible with the material from which sheet 10 is formed is suitable, for example, an acrylic emulsion adhesive.

Sheet 10 has points of weakness 11 formed substantially across the entire label. A point of weakness is a localised physical weakness of the sheet material. The weakness results from scores, indentations, perforations or cuts formed either in a surface of the sheet material, or alternatively the localised points of weakness extend through the sheet material. The points of weakness lead to preferential ‘fracturing’ of the sheet material at the site of a point or points of weakness when a force is applied to the sheet material. Labels incorporating these points 11 allow such labels to be applied to any kind of blister pack without redesign and the re-manufacture of new labels specific to match the medicament retaining cavities of alternative blister pack designs. The application of labels produced according to the present invention leads to a reduction in the manufacture and labour costs as there is no need to align precisely the points of weakness of the label with the medicament containing cavities of the blister pack, as is the case with conventional labels. The advantage of a label of the present invention is that it is not necessary to define the medicament release zones, corresponding to the location of a medicament as with conventional blister pack labels.

In FIGS. 1a and 1b, points of weakness can be seen formed as semi-perforations in an upper and lower surface of the label, respectively. In an alternative embodiment, shown in FIG. 2, points of weakness extend as complete perforations from an upper surface and through the label to the lower surface thereof

The label 9 may be applied to the blister pack during the manufacturing process. Alternatively, the label may be applied to a pre-formed blister pack, for example, by an end user.

Referring to FIG. 3, there is shown an exploded blister pack comprising a moulded plastics tray 21 including a plurality of moulded cavities or recesses 17 each, in use, containing a medicament in the form of a capsule or tablet 18. The tablets are held in place by means of a medicament retaining sheet 13. Retaining sheet 13 is adhered to tray 21 by means of an adhesive 20. However other means of bonding may be suitable, for example, corona discharge, depending upon the nature of the materials constituting the medicament retaining sheet 13.

The medicament retaining sheet 13 illustrated in FIG. 3 is a laminate comprising bonded first 15 and second 10 sheet materials. Suitably, the first sheet material 15 is a sheet material of the type conventionally used in the production of blister packs. For example, the first sheet material 15 may be a thin metallic foil or a metalised plastics sheet material. In a preferred embodiment the second sheet 10 includes points of weakness 11 formed substantially across the entire label. Points of weakness 11 are formed in an upper surface of the second sheet (FIG. 3a). In alternative embodiments, points 11 may be formed in a lower surface thereof (FIG. 3b). Alternatively, the points of weakness may extend through the second sheet (FIG. 3c). The second sheet 10 is formed from any suitable material such as metal foil, metalised plastics, plastics or paper. Second sheet 10 is preferably a sheet material having a printable surface, such as a paper material. Wood or pulp based materials are particularly preferred, but synthetic materials, such as non-woven or spun synthetic materials, such as polymers, including polyethylene equally useable. Coated papers, such as gloss or semi-gloss machine-coated or blade-coated papers are preferred, such as semi-gloss machine-coated paper having a thickness of about 75 μm and a weight (grammage) of 60-90 g/m².

The medicament retaining sheet 13 is adhered to the tray 21 by adhesive 20 contacting first sheet material 15. The adhesive 20 may be applied to the retaining sheet 13 or directly to the tray 21, for example by roller-coating. The medicament retaining sheet 13 can be applied to the tray 21 during the manufacturing process.

An alternative medicament retaining sheet 13 is illustrated in FIG. 4 in which a single medicament retaining layer 22 is used which further comprises points of weakness 23, 24 in either an upper or lower surface of the sheet, respectively (FIGS. 4a and 4b).

As above, the medicament retaining sheet 13 is adhered to the tray 21 by adhesive 20 contacting the sheet material 22. The adhesive 20 may be applied to the retaining sheet 13 or directly to the tray 21, for example by roller-coating. However other means of bonding may be suitable, for example, corona discharge, depending upon the nature of the materials constituting the medicament retaining sheet 13. The medicament retaining sheet 13 can be applied to the tray 21 during the manufacturing process.

FIG. 5 shows, in views (a) to (e), a number of exemplary designs of points of weakness 11 formed in labels 9 and medicament retaining sheets 13 of the present invention. The points take the form of simple regions of slits, as exemplified in

FIGS. 5a & 5b in which lines of slits transverse the sheet horizontally and diagonally, respectively. Alternatively, the points comprise combinations of intersecting perpendicular lines of slits which transverse the sheet longitudinally and latitudinally, as illustrated in FIG. 5c. In further alternative embodiments the intersecting lines will be arranged diagonally (not shown), as would be recognised by the skilled person. The points of weakness will also take the form of repeating patterns such as the crosses illustrated in FIG. 5d. It is also recognised that the lines of slits can be formed from uniformly sized slits as illustrated in FIGS. 5a to d, but may also be formed from slits of different lengths as exemplified in FIG. 5e in which lines comprising slits of a particular length perpendicularly intersect lines of slits of a different length. Other arrangements will be immediately apparent to the skilled person. As shown, the distribution of points of weakness may be uniform and regular. In alternative embodiments, the distribution may be irregular or random.

In preferred embodiments, the lines of weakness are spaced such that each medicament retaining cavity is overlaid by more than one line of weakness.

In use, the patient applies a force to the underside of the blister pack adjacent a recess 17. The force applied allows the label 9 or medicament retaining sheet 13 to fracture about the points of weakness 11, 23, 24 and allows, in a conventional manner, the tablet 18 to perforate the foil (not shown) or medicament retaining sheet, in accordance with the present invention, of the blister pack (not shown), so releasing the tablet 18.

In a modification to this embodiment, the label 9 is applied to the moulded plastics tray prior to application of the foil sheet.

1. A medicament blister pack label comprising a plurality of points of weakness formed across substantially the entire label.

2. A label as claimed in claim 1 wherein the points of weakness are formed by a plurality of perforations.

3. A label as claimed in claim 1 wherein the points of weakness are formed by a plurality of cuts.

4. A label as claimed in claim 1 wherein the points of weakness are formed as a plurality of substantially parallel lines.

5. A label as claimed in claim 1 wherein the points of weakness are formed as transecting sets of substantially parallel lines.

6. A label as claimed in claim 1 wherein the label has an upper surface and a lower surface.

7. A label as claimed in claim 6 wherein the points of weakness are formed in an upper surface of the label.

8. A label as claimed in claim 6 wherein the points of weakness are formed in an lower surface of the label.

9. A label as claimed in claim 1 wherein the points of weakness extend through the label.

10. A label as claimed in claim 1 wherein the label comprises a single sheet material.

11. A label as claimed in claim 10 wherein the label is a paper material.

12. A label as claimed in claim 1 wherein said label has a weight of 20 g/m², or more, preferably from 50 to 400 g/m²; more preferably from 60 to 200 g/m², most preferably from 70 to 150 g/m².

13. A label as claimed in claim 12 wherein said label has a weight of from 60 to 120 g/m², preferably about 84 g/m².

14. A label as claimed in claim 1 wherein the label comprises a laminated material.

15. A label as claimed in claim 14 wherein the laminated material comprises a first sheet having first and second faces and a second sheet having first and second faces, wherein the first face of the second sheet and the second face of the first sheet are opposed and bonded together.

16. A label as claimed in claim 15 wherein the first sheet comprises a metal foil or metallized plastics material.

17. A label as claimed in claim 16 wherein the second sheet comprises a paper material.

18. A label as claimed in claim 17 wherein the second sheet has a weight of from 60 to 120 g/m².

19. A medicament blister pack label as claimed in claim 15 wherein the first sheet has a weight of from 15 to 100 g/m².

20. A label as claimed in claim 15 wherein the first sheet has a thickness of from 20 to 60 μm.

21. A label as claimed in claim 15 wherein the second sheet comprises a printable material.

22. A label as claimed in claim 15 wherein the second sheet has a thickness of from 30 to 400 μm.

23. A medicament blister pack comprising a moulded plastics or metallized tray including a plurality of moulded cavities or recesses each containing a medicament held in place by means of a foil retaining sheet, further comprising a label as claimed in claim 1.
